(19) United States
(12) Patent Application Publication
(10) Pub. No.: US 2009/0152770 A1
(43) Pub. Date: Jun. 18, 2009

(54) MECHANICALLY COLLAPSIBLE CORE FOR INJECTION MOLDING

(75) Inventors: PAUL ROBERT MIKAC, Newport News, VA (US); DALE ROBERT STRAIN, Belvidere, IL (US)

Correspondence Address: FITZPATRICK CELLA HARPER & SCINTO, 30 ROCKEFELLER PLAZA, NEW YORK, NY, 10112, US

(73) Assignee: CANON VIRGINIA INC., Newport News, VA (US)

(21) Appl. No.: 12/187,916

(22) Filed: Aug. 7, 2008

Related U.S. Application Data
(60) Provisional application No. 60/954,554, filed on Aug. 7, 2007.

(51) Int. Cl. B29C 45/40

(52) U.S. Cl. 264/334; 425/577

(57) ABSTRACT

The invention relates to a mechanically-collapsible core device includes a central pin having a plurality of engaging members, a plurality of first collapsible core members each having an engaging member that engages with a respective engaging member of the central pin, a base member having a plurality of engaging members, and a plurality of second collapsible core members each having an engaging member that engages with a respective engaging member of the base member. The pin is retracted from a home position, thereby causing the first core members to collapse inward. The base member is then retracted, thereby causing the second core members to translate inward and linearly. The result is that the core device collapses inward in size so as to permit the device to be removed from the inside of a molded article.

### CROSS-REFERENCE TO RELATED APPLICATION

This application claims priority under 35 U.S.C. § 119(e) to provisional Application No. 60/954,554, filed on Aug. 7, 2007, the contents of which are incorporated by reference as if set forth in full herein.

### BACKGROUND OF THE INVENTION

1. Field of the Invention

This present invention relates to core devices for injection molding processes, and in particular, relates to a mechanically-collapsible core device for use in injection molding of articles having a distinct undercut.

2. Related Background Art

In the field of molding hollow plastic articles, blow molding has been the preferred method of manufacturing such articles. The most commonly known types of blow molding procedures are extrusion blow molding, injection blow molding, and stretch blow molding. In extrusion blow molding, plastic is melted and extruded into a hollow tube (a parison). This parison is then captured by closing it into a cooled metal mold. Air is then blown into the parison, inflating it into the shape of the hollow bottle, container or part. After the plastic has cooled sufficiently, the mold is opened and the part is ejected.

The process of Injection Blow Molding (IBM) is used for the production of hollow glass and plastic objects in large quantities. In the IBM process, the polymer is injection molded onto a core pin; then the core pin is rotated to a blow molding station to be inflated and cooled. This is the least-used of the three blow molding processes, and is typically used to make small medical and single serve bottles. The process is divided into three steps: injection, blowing and ejection.

The injection blow molding machine is based on an extruder barrel and screw assembly which melts the polymer. The molten polymer is fed into a manifold where it is injected through nozzles into a hollow, heated preform mold. The preform mold forms the external shape and is clamped around a mandrel (the core rod) which forms the internal shape of the preform. The preform consists of a fully formed bottle/jar neck with a thick tube of polymer attached, which will form the body.

The preform mold opens and the core rod is rotated and clamped into the hollow, chilled blow mold. The core rod opens and allows compressed air into the preform, which inflates it to the finished article shape.

After a cooling period the blow mold opens and the core rod is rotated to the ejection position. The finished article is stripped off the core rod and leak-tested prior to packing. The preform and blow mold can have many cavities, typically three to sixteen depending on the article size and the required output. There are three sets of core rods, which allow concurrent preform injection, blow molding and ejection.

Another application of injection blow molding is in the production of soft elastic gelatin capsules for pharmaceutical applications. Two strips of gelatin are pressed together in a rotary die which cuts out the desired shape of capsule while the fill liquid is injected. Afterwards, they are cooled and dried to yield a firm, strong capsule.

In the Stretch Blow Molding (SBM) process, the plastic is first molded into a “preform” using the Injection Molded Process. These preforms are produced with the necks of the bottles, including threads (the “finish”) on one end. These preforms are packaged, and fed later (after cooling) into an EBM blow molding machine. In the SBM process, the preforms are heated (typically using infrared heaters) above their glass transition temperature, then blown using high pressure air into bottles using metal blow molds. Usually the preform is stretched with a core rod as part of the process. The stretching of some polymers, such as PET (Polyethylene terephthalate) results in strain hardening of the resin, allowing the bottles to resist deforming under the pressures formed by carbonated beverages.

While blow molding has worked well for some types of hollow articles, more dimensional precision may be required for other articles. Better dimensional precision can be obtained via injection molds (distinguished from blow injection molding). Injection molding is a manufacturing technique for making parts from both thermoplastic and thermosetting plastic materials in production. Molten plastic is injected at high pressure into a mold, which is the inverse of the product's shape. After a product is designed by an Industrial Designer or an Engineer, molds are made by a moldmaker (or toolmaker) from metal, usually either steel or aluminum, and precision-machined to form the features of the desired part. Injection molding is widely used for manufacturing a variety of parts, from the smallest component to entire body panels of cars. Injection molding is the most common method of production, with some commonly made items including bottle caps and outdoor furniture.

However, to date, injection molding has not been conducive for the production of hollow articles, and particularly for hollow articles that have an internal undercut near the opening. In order to form hollow parts having an internal undercut using the injection molding process, a central core portion of the mold is required. Since the article is hollow with an undercut (i.e., a portion of the article is larger in size (e.g., diameter) than the portion near the opening), the core is not easily removable from the article after the article has cooled. Thus, what is needed is a core that is easily removable from the finished article for use in injection molding processes.

### SUMMARY OF THE INVENTION

The present invention addresses the foregoing problems by providing a mechanically-collapsible core device for use in injection molding. According to the invention, the mechanically-collapsible core device is made of a plurality of mechanically co-operable components that function together to collapse into a smaller diameter in order to be easily removed from the article. In more detail, the device includes a central pin having a plurality of engaging members. For example, the pin may be cylindrical with grooves cut along its length as the engaging members. One notable aspect is that the pin has a tapered diameter, at least partially along its length, and the depth of the grooves is such that they are deeper at the smaller end of the taper than at the larger end of the taper.

The device also has a plurality of first collapsible core members each having an engaging member, such as a rail, that engages with a respective engaging member (or groove) of the central pin. The design of the pin and its grooves, and the rails are such that, when the pin is translated in a first direction along a central axis of the pin while the first collapsible core members remain stationary relative to the translation of the pin, the grooves of the pin and the respective rails of the first collapsible core member cooperate to cause each of the first collapsible core members to translate toward the central axis of the pin. This is referred to as a first collapse in operating the device of the invention.

The device also includes a base member having a plurality of engaging members, such as grooves, for engaging another set of collapsible core members. In this regard, the base member may be designed to include a cylindrical portion in which one end has a shoulder, and extending therefrom is a conical portion. The conical portion has cutouts that allow the first collapsible core members to be positioned therein, and the grooves are cut in the conical surfaces adjacent the cutouts. The base member may also include some holes through the cylindrical portion so that the first collapsible core members can be loosely connected to the base. Additional holes may be used for allowing a pin to be inserted to engage the additional collapsible core members in order to limit the linear translation of those additional members.

The additional collapsible core members may be referred to as second collapsible core members and they each have an engaging member, such as a rail, that engages with a respective engaging member (or groove) of the base member. The rails of the second collapsible core members and the grooves in the conical surface of the base member act to allow the second collapsible core members to translate both inward and lengthwise simultaneously.

Thus, when the device is assembled at a home position, the central pin is slidably engaged into an orifice of the base member, the first collapsible core members are inserted into the cutouts of the base member with the rails of the first collapsible core members being engaged with the grooves of the central pin inserted through the orifice, and the rails of the second collapsible core members are engaged with the grooves in the conical portion of the base member with a first end of the second collapsible core members engaging the shoulder portion of the base member. The central pin is inserted through the orifice to a depth such that the first end of the pin, a first end of each first collapsible core member, a first end of the base member, and a first end of each second collapsible core member are substantially even, whereby a second end of each first collapsible core member is adjacent the shoulder portion of the base member, and a second end of each second collapsible core member is adjacent the shoulder portion of the base member. When the device is to be collapsed so that it can be removed from the molded part, the device is reconfigured from the home position to a first retracted position by retracting the central pin from the orifice of the base member a predetermined amount. The retraction of the pin results in each of the first collapsible core members engaged with the pin translating toward the central axis of the base member with the second end of each first collapsible core member remaining substantially adjacent the shoulder portion of the base member. In continuing the collapse of the device, the base member is then retracted a predetermined amount in the same direction as the retraction of the central pin. The retraction of the base member results in each of the second collapsible core members translating both toward the central axis of the base member and linearly along length of the central axis of the base member so that the second end of each second collapsible core member translates away from the shoulder portion of the base member. The result is that the core device of the invention is collapsed and can be easily withdrawn from the molded part.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

FIG. 1 is an end view of a mechanically-collapsible core device according to the invention.

FIG. 2 is a side view of a mechanically-collapsible core device according to the invention.

FIG. 3 is a perspective view of the mechanically-collapsible core device assembled in the home position.

FIG. 4 is a cross-sectional view of a molding fixture with a mechanically-collapsible core device of the invention installed therein.

FIG. 5 is a perspective view of a central pin for the mechanically-collapsible core device of the invention.

FIG. 6 is a side view of a central pin for the mechanically-collapsible core device of the invention.

FIG. 7 is a cross-sectional view of a central pin for the mechanically-collapsible core device of the invention.

FIG. 8 is a perspective view of a first collapsible core member of the invention.

FIG. 9 is side view of a first collapsible core member of the invention.

FIG. 10 is an end view of a first collapsible core member of the invention.

FIG. 11 is a perspective view of a base member of the invention.

FIG. 12 is an end view of a base member of the invention.

FIG. 13 is a side view of a base member of the invention.

FIG. 14 is a perspective view of a second collapsible core member of the invention.

FIG. 15 is a front view of a second collapsible core member of the invention.

FIG. 16 is a side view of a second collapsible core member of the invention.

FIG. 17 is a perspective view of the mechanically-collapsible core device depicting the initial collapse of the first collapsible core members.

FIG. 18 is a perspective view of the mechanically-collapsible core device depicting the secondary collapse of the second collapsible core members.

FIG. 19 is an exploded view depicting component parts of the mechanically-collapsible core device of the invention.

FIG. 20 is a cross-sectional view of a molding fixture after a first stage of separation in the process of collapsing the core device of the invention.

### DETAILED DESCRIPTION OF THE PREFERRED EMBODIMENTS

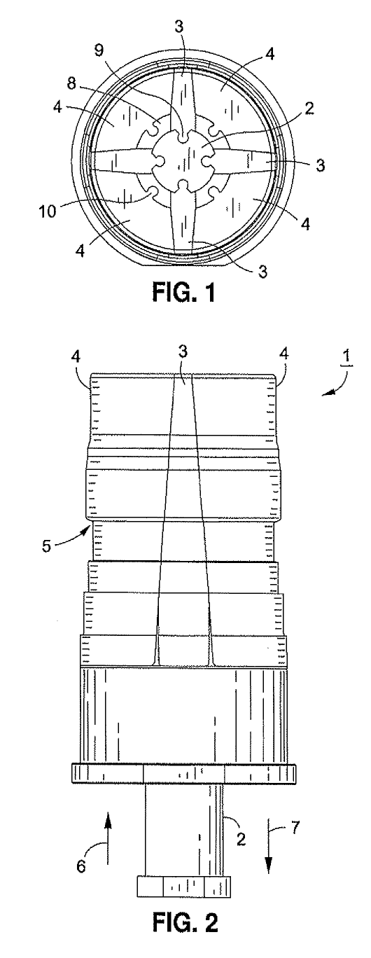

In FIGS. 1 and 2, a mechanically-collapsible core device 1 according to the invention is seen to include a central pin 2, a plurality of first collapsible core members 3 and a plurality of second collapsible core members 4. The precise external shape of the mechanically-collapsible core device is, of course, dependent upon the internal surface design of the part being molded. Thus, the external shape shown in the drawings is merely representative of one article of manufacture. However, one object of the invention is to provide a mechanically-collapsible core device that can be easily removed from articles that include an internal undercut. In FIG. 2, reference numeral 5 depicts an undercut in the article being molded. For instance, the undercut may be a lip in a part.

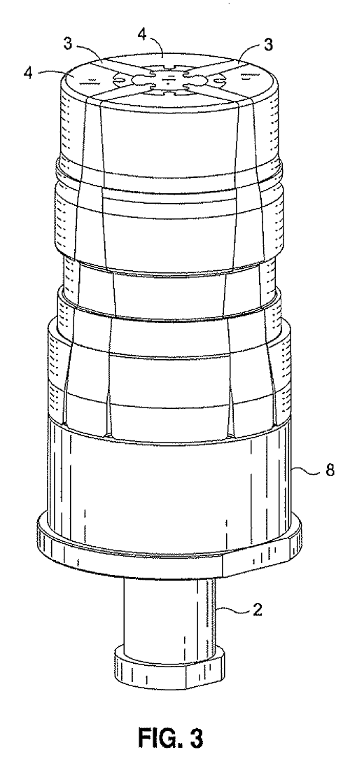

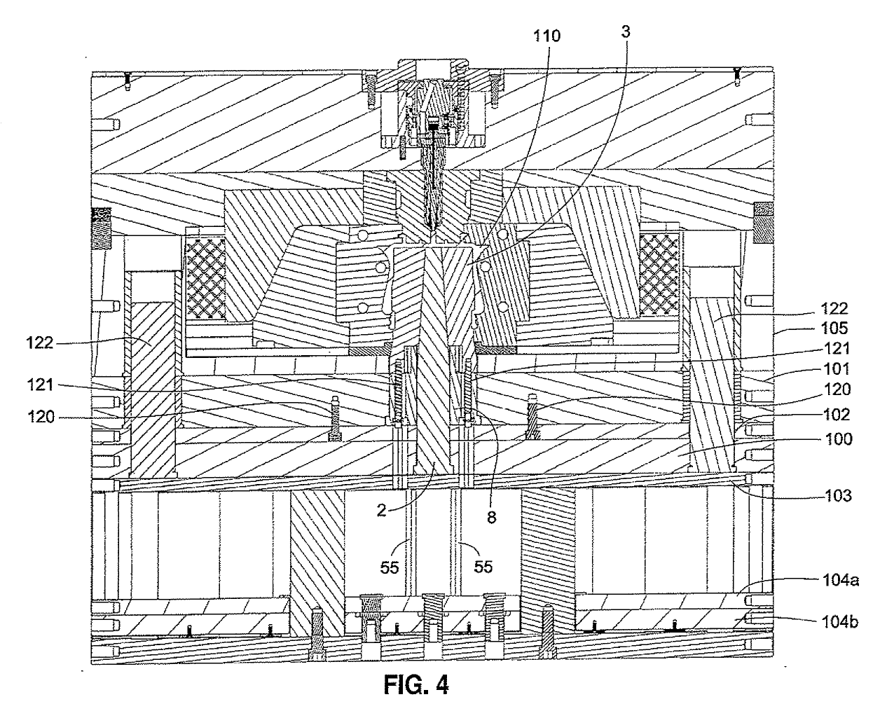

In operation, mechanically-collapsible core device 1 is inserted into another portion of a molding fixture which forms the exterior surface of the article. When the core assembly is ready to be inserted into the molding fixture to mold the part, it is assembled with each of the components in a “home position”. An example of a mechanically-collapsible core device assembled at the home position is shown in FIG. 3. An example of a molding fixture with the mechanically-collapsible core device installed therein is shown in FIG. 4. After the article is molded, the core is collapsed and removed as will be discussed below.

In one representative embodiment, a mechanically-collapsible core device of the invention is made of four main components: a central pin 2, a plurality of first collapsible core members 3, a base member 8, and a plurality of second collapsible core members 4. Each of these four main components are assembled in a manner to be described below so as to form the mechanically-collapsible core device.

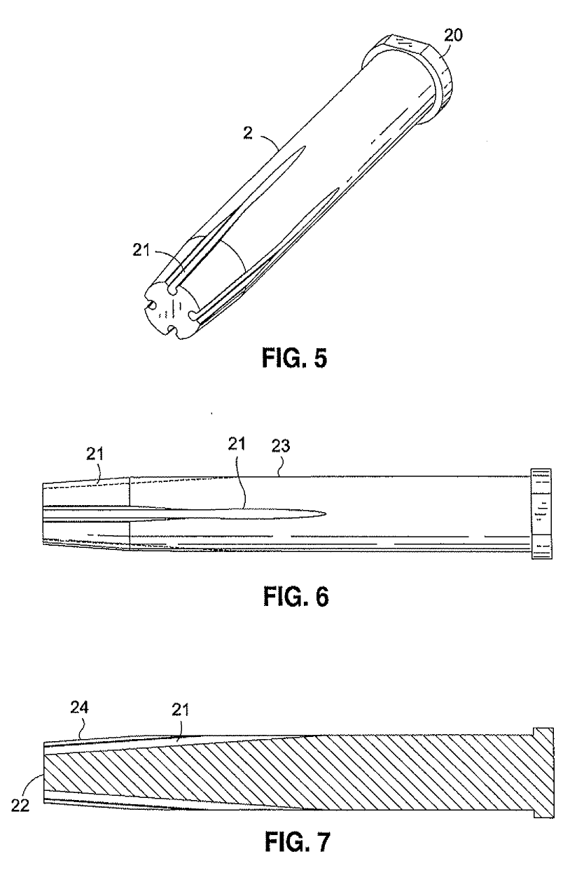

FIGS. 5 to 7 depict one example of a central pin 2 of the mechanically-collapsible core device of the invention. As seen in FIGS. 5 to 7, central pin 2 is generally cylindrical in shape with a shoulder 20 at one end. The shoulder 20 is utilized to retain the pin at a fixed position within the molding fixture as will be described in more detail below. As shown in FIGS. 5 to 7, central pin 2 is seen to have a tapered diameter that tapers down in size from approximately midway along the length of the pin to one end 22 of the pin opposite the shoulder 20. The degree of taper is a matter of design choice. However, in practicing the invention, the inventors have employed a 4 degree taper. Central pin 2 is also seen to include a plurality of grooves 21. The grooves 21 constitute engaging members that, as will be described later, engage the first collapsible core members 3. In FIGS. 5 to 7, each groove is seen to be a cylindrical shaped groove cut into the pin. However, other shapes, such as a rectangular or square shaped groove, could be utilized instead. In the present example, four grooves are seen to be cut into the pin in relation to the use of four first collapsible core members 3. However, the number of grooves is dependent upon the design preference and no specific number of grooves is required other than that the number of grooves be sufficient to accommodate the number of first collapsible core members being employed.

FIGS. 5 to 7 also show that the grooves 21 are deeper at the smaller diameter end 22 of the pin than they are at the middle portion 23 of the pin. In addition, although not necessary, the edge portions of the grooves may include a chamfer 24 so as to reduce the likelihood of interference between the groove and an engaging member of the first collapsible core members.

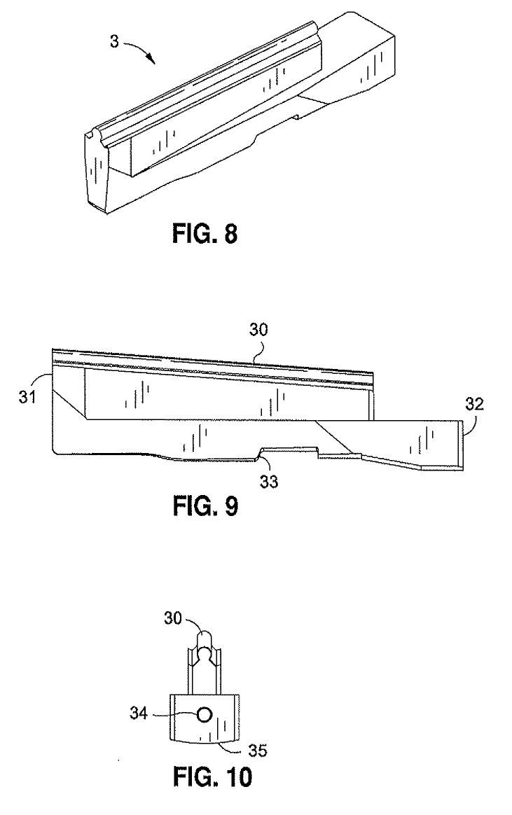

FIGS. 8 to 10 depict one example of a first collapsible core member 3 of the invention. As seen in FIGS. 8 to 10, first collapsible core member 3 is seen to include an engaging member 30. Engaging member 30 is preferably designed as a rail to engage the grooves 21 of central pin 2. That is, as seen in FIGS. 8 to 10, engaging member 30 is a rail having a generally cylindrical shape designed to match the cylindrical groove of the central pin, and is formed so as to permit sliding engagement between the rail and the groove 21. That is, the diameter of the rail is slightly smaller than the diameter of the groove so that the rail of engaging member 3 can freely slide along the surface of the groove 21. In addition, the engaging member 30 is seen to be formed with a taper that preferably matches the taper of the central pin. Thus, utilizing the 4 degree taper of the central pin described above, the inventors herein have utilized a corresponding 4 degree taper for the engaging member of the first collapsible core member 3.

First collapsible core member 3 is also seen to include a first end 31 and a second end 32. First end 31 is generally formed to correspond to a shape of the article being molded. Second end 32, as will be described in more detail below, engages a shoulder of a base member. In this regard, the second end 32 may include a hole 34, which may be threaded or have a threaded insert installed so that a fastener may be installed to attach the first collapsible core member to the base member in a manner that allows the first collapsible core member to move toward the center axis of the base member, but to retain the relative lengthwise positioning of the first collapsible core member in relation to the base member. That is, the first collapsible core member slides inward and outward toward the central axis of the base member, but retains its relative positioning against the shoulder of the base member.

First collapsible core member 3 shown in the figures is preferably designed for an article to be molded that is round in shape. Thus, the outer peripheral surface 35 of the core member forms part of a cylindrical shape of the molded article. In addition, the outer peripheral surface of the first collapsible core member 3 may include an undercut 33 (corresponding to undercut 5 in FIG. 2) along the outer peripheral surface. This undercut is also design-dependent based on the article being formed. However, the undercut is shown to emphasize the reliable removal of the core member from an article that may include such an undercut, or overhang once the part is molded.

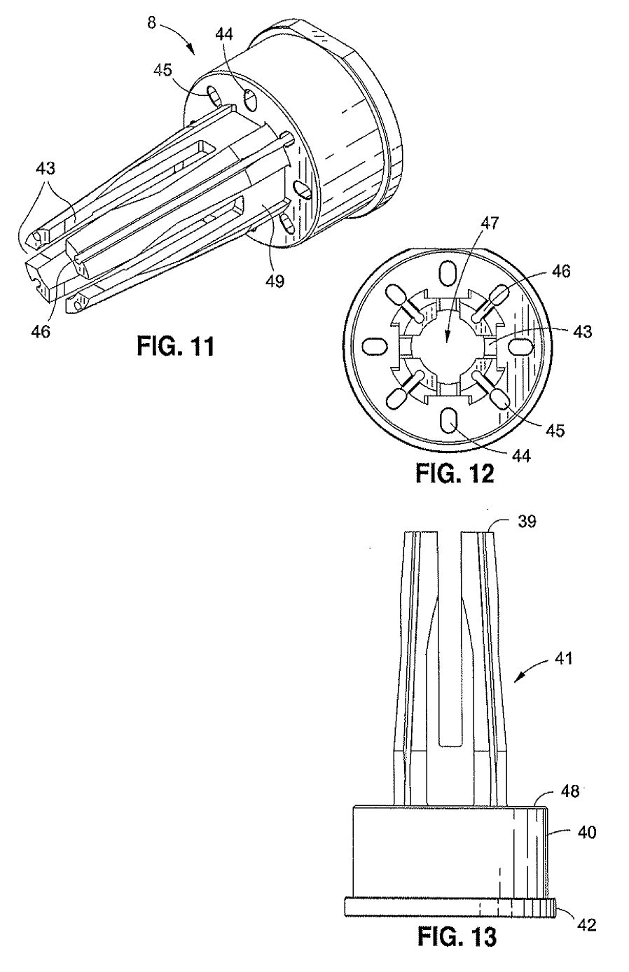

FIGS. 11 to 13 depict one example of a base member 8 according to the invention. As seen in the figures, base member 8 is preferably formed with a generally cylindrical portion 40 and a generally conical portion 41. A shoulder 42 may also be included at one end of the base member. The shoulder 42 is similar to the shoulder 20 of central pin 2 in that it is sandwiched between two plates to retain the relative positioning of the base member when the mold is opened (to be described below). One end of the cylindrical portion 40 adjacent the conical portion 41 may form a shoulder 48, which will be discussed in more detail below. Holes 44 and 45, which are preferably slotted holes, are formed through the cylindrical portion 40 of the base member 8. Each of holes 44 and 45 are preferably perpendicular to the shoulder 48, and the number of holes 44 in base member 8 correspond to the number of first collapsible core members employed, while the number of holes 45 correspond to the number of second collapsible core members employed. In the present example, four holes 44 and four holes 45 are present in base member corresponding, respectively, with four first collapsible core members 3 and four second collapsible core members 4.

A hole (orifice) 47 is also formed through the center of the base member 8, including extending through both the cylindrical portion 40 and the conical portion 41. The diameter of the hole 47 is preferably slightly larger than the untapered diameter of the central pin 2 so that the central pin 2 can slidably fit within the hole 47.

Conical portion 41 preferably has a tapered external diameter that is smaller at a first end 39 of the base member opposite the cylindrical portion 40 and tapers to a larger diameter closer to the shoulder 48. The amount of taper is, of course, design dependent, but taking into consideration the size of hole 47 and grooves 46 (to be described later), the taper should be such that sufficient material remains to support the end of the conical portion without failure. That is, as seen in the figures, conical portion 41 has grooves 46 cut therein. Grooves 46 constitute engaging members that engage with rails in the second collapsible core members. Like grooves 21 in central pin 2, grooves 46 are preferably cylindrical in shape, preferably run the entire length of the taper of the conical portion 41 and are relatively constant in depth. As seen in the figures, grooves 46 may, however, form a part of holes 45.

The conical portion 41 of base member 8 also includes cutouts 43 to accommodate the first collapsible core members. That is, each cutout 43 allows the engaging member 30 of the first collapsible core members 3 to be engaged with the grooves 21 of central pin 2. As seen in the figures, the cutouts are generally rectangular and extend through opposing faces of the conical portion 41. In addition, the cutouts extend lengthwise through the smaller diameter portion of the conical portion 41. The actual size and length of each cutout is, of course, design dependent, but is preferably designed to accommodate the engaging member (rail) 30 of the first collapsible core member. As also seen in FIG. 11, each cutout may also include a recessed face 49 to abut a corresponding face of the first collapsible core member 3.

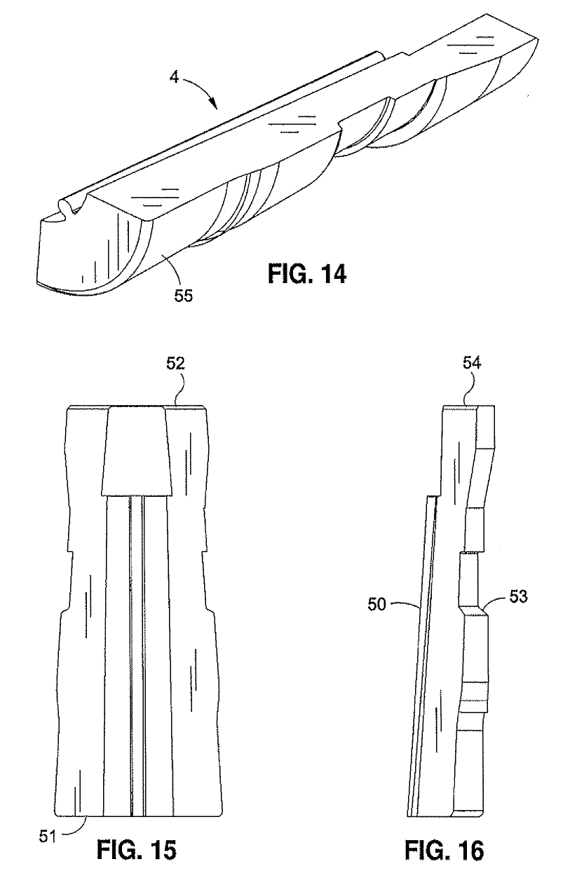

FIGS. 14 to 16 depict one example of a second collapsible core member 4 of the invention. Second collapsible core member 4 includes an engaging member 50 which is designed to engage the grooves 46 of base member 8. As seen in the figures, engaging member 50 is preferably a cylindrical shaped rail and is preferably formed at an angle commensurate with the angle of conical portion 41 of base member 8. In addition, the surface area surrounding the rail is preferably formed with a curvature commensurate with the curvature of conical portion 41. A surface 51 at a first end of the second collapsible core member 4 is formed in a manner to match the surface 31 of first collapsible core member 3 and is design-dependent based on the molded article. A surface 52 at a second end of the second collapsible core member 4 engages the shoulder of base member 8. In this regard, the second end 52 may include a hole 54 (not shown) which may be threaded or have a threaded insert installed so that a fastener may be installed. As will be described in more detail below, a pin may be installed in hole 54 through hole 45 of the base member, with the pin being used to retract the second collapsible core members back to their home position.

Second collapsible core member 4 shown in the figures is preferably designed for an article to be molded that is round in shape. Thus, the outer peripheral surface 55 of the core member forms part of a cylindrical shape of the molded article. In addition, the outer peripheral surface 55 of the second collapsible core member 4 may include an undercut 53 along the outer peripheral surface, which is commensurate with undercut 33 of the first collapsible core member 3.

The mechanically-collapsible core device of the invention is generally to be assembled within the molding fixture device of FIG. 4. Thus, the assembly and operation of the mechanically-collapsible core device within the fixture will described in more detail below. However, merely for illustration purposes of how the component parts of the device operate together, a description will now be made of the mechanically-collapsible core device being assembled by itself, outside of the molding fixture.

Referring to FIG. 19, depicted therein is an exploded view of the component parts that form the mechanically-collapsible core device of the invention. In assembling the device, base member 8 and central pin 2 are engaged with one another, with the smaller diameter end of central pin being inserted into hole 47 of base member 8. Each of the first collapsible core members 3 are then assembled onto the device. In this regard, rail 30 of each of the first collapsible core members 3 are engaged with a groove 21 in central pin 2 and are slid into the groove until end 32 of the first collapsible core member engages shoulder 48 of the base member. Each of the first collapsible core members will then be engaged with the pin through the cutout 43 in the base member.

The hole 34 of the first collapsible core member 3 is aligned with slotted hole 44 in base member 8. A fastener (e.g., a screw, not shown) is inserted through slotted hole 44 of the base member 8 to engage the hole 34 of the first collapsible core member, and the fastener is tightened as desired. Once the fastener is inserted, the first collapsible core member 3 is attached to the base member, but a sufficient clearance is provided between surface 32 of the first collapsible core member and shoulder 48 of base member 8 so that the first collapsible core member can slidably engage the cutout, moving inward and outward toward from the central axis of the base member 8.

Next, the second collapsible core members 4 are assembled onto the device. In this regard, rails 50 of each second collapsible core member are engaged with a respective groove 46 in the conical portion 41 of base member 8, with surface 52 being inserted first. The second collapsible core member is then slid down toward shoulder 48 of the base member until surface 52 of the second collapsible core member engages shoulder 48 of base member 8. A pin (not shown) can then be inserted through hole 45 of base member 8 to engage threaded hole 54 in the second collapsible core member. In this regard, on purpose of the pin is to retract the second collapsible core members from their collapsed position back to their home position, as will be described in more detail below in connection with the operation of the molding fixture.

Thus, as seen in FIG. 3, the mechanically-collapsible core device of the invention thus assembled, and by inserting the pin 2 until end 22 is relatively flush with end 39 of the base member, and retaining the second collapsible core members with surface 52 engaged with shoulder 48 of base member 8, the home position of the device is obtained.

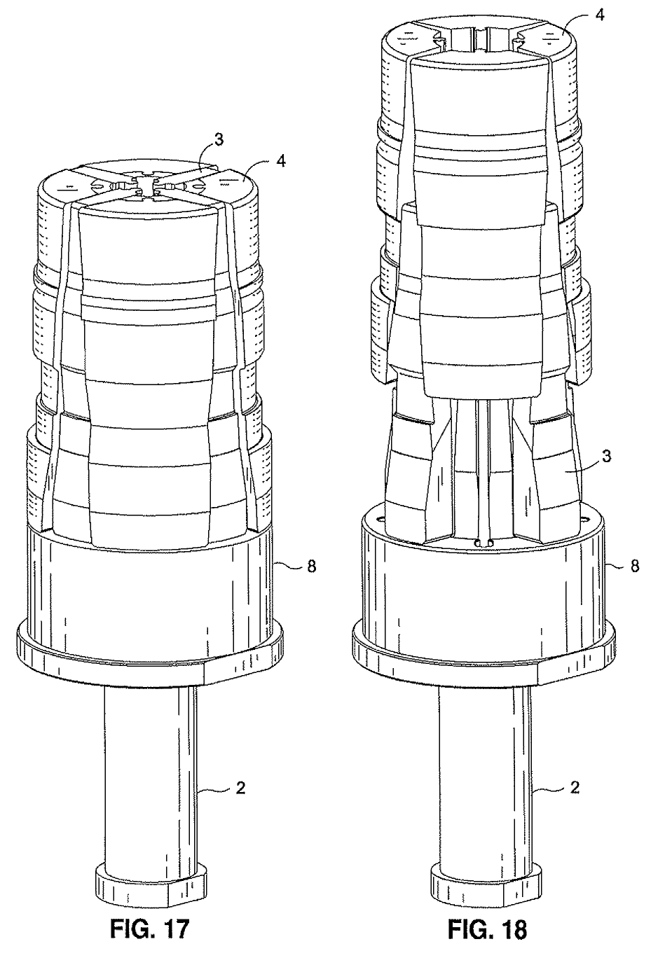

In operating the mechanically-collapsible core device itself, for illustration purposes only, FIG. 17 depicts a first stage of collapse. In the first stage, pin 2 is held at a constant position while the base member, having the first collapsible core members attached thereto, and second collapsible core members, are translated axially to advance those component parts away from shoulder 20 of pin 2. With the design implemented by the inventors, a three inch translation is performed. As the translation occurs, each of the first collapsible core members collapse inward (i.e., translate inward toward the central axis of the base member. The result of first stage of collapse is seen in FIG. 17.

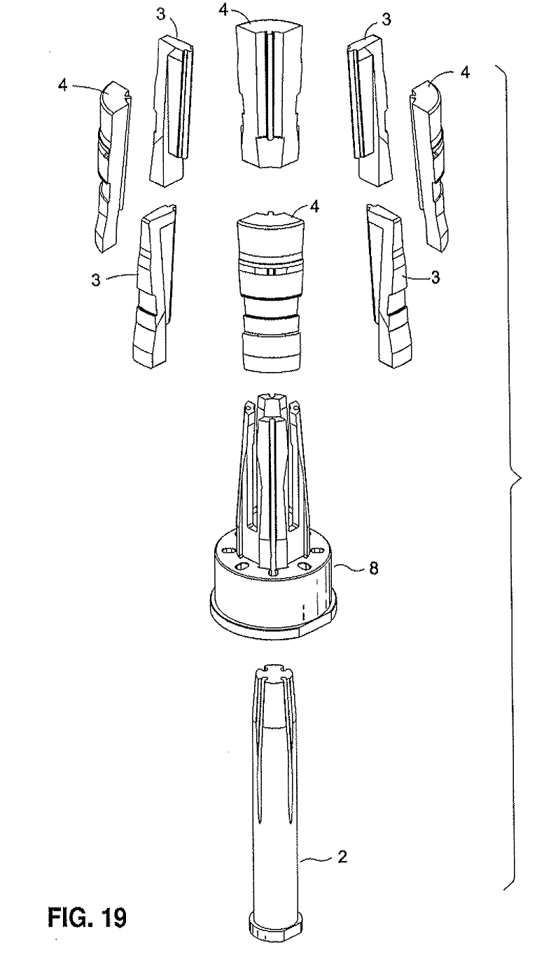

After the first stage of collapse, a second stage of collapse for the core device is initiated. In the second stage, the central pin 2 and base member 8, with the first collapsible core members 3 attached thereto, are held at a relatively constant position from that at the end of the first stage of collapse, while each of the second collapsible core members are translated. That is, each of the second collapsible core members are translated lengthwise so that the surface 52 disengages from surface 48 of the base member. In practicing the invention, the inventors herein have employed a three inch translation of each of the second collapsible core members. As each of the second collapsible core members is translated, they collapse inward toward the axis of the base member. The result of the second stage of collapse is seen in FIG. 18. Thus, as a result, the mechanically-collapsible core device of the invention, after completion of the second stage of collapse, is collapsed so that the molded article can be removed from the molding fixture.

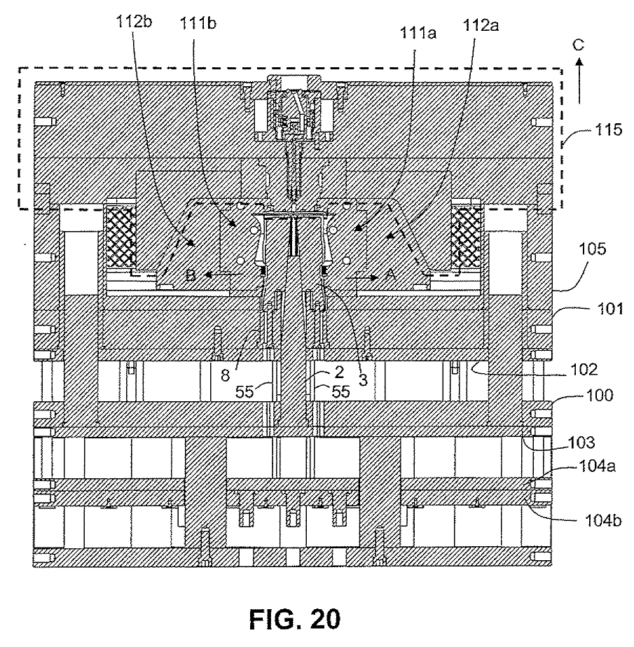

Referring back to FIG. 4, which is a cross-sectional view of an injection molding fixture in which the mechanically-collapsible core device of the invention may be employed, the assembled mechanically-collapsible core device is seen installed therein. In FIG. 4, the device is shown at its “home position” and the installation of the core device, and its operation within the molding fixture, will now be described with regard to FIGS. 4 and 20. It should be noted that the installation/assembly of the mechanically-collapsible core device described below is merely illustrative of one example of how the core device can be assembled in the molding fixture and the precise steps used can be rearranged, so long as the core device ultimately is assembled/installed as in the fixture as seen in the drawings.

When assembling/installing the mechanically-collapsible core device in the molding fixture, central pin 2 is inserted into a mounting hole in plate 100. The hole is keyed so as to position central pin 2 within the hole utilizing the flat-key surface cut into shoulder 20 of pin 2 (see, e.g., FIG. 5). Plate 100 is connected to plate 103 so as to mount the pin between the two plates. Base member 8 is installed in a hole in plate 101, with the hole in plate 101 also being keyed so as to position base member 8 within the hole utilizing the flat-key surface cut into shoulder 42 of base member 8 (see. e.g., FIG. 11). Plate 102 is connected to plate 101 utilizing screws 120. Plate 101, assembled with plate 102 and base member 8 can then be installed over guide pins 122.

First collapsible core members 3 and second collapsible core members can be assembled into the fixture. Each of the four first collapsible core members 3 are engaged with a groove 21 in pin 2 and slid downward toward surface 48 of base member 8. Screws 121 can then be utilized to connect each of the first collapsible core members to base member 8. Each of the second collapsible core members 4 can also be installed in a respective groove 46 of base member 8 and slid downward toward surface 48 of base member 8. Pins 55 can then be installed through holes in plates 103, 100 and 102, and then through holes 45 in base member 8 to engage the threaded hole 54 in the second collapsible core member 4. The opposite end of pins 55 include a keyed shoulder that is attached between plates 104a and 104b. Thus, when plates 104a and 104b are retracted as shown in FIG. 4, and the adjoining surfaces of plates 100 and 102 abut one another, the mechanically-collapsible core device of the invention is installed in its home position. The remaining elements of the molding fixture are then assembled to complete the molding fixture, but those components are not necessarily of importance to the core device of the invention. However, the operation of some of those components, to aid in the understanding of the operation of the core device of the invention in a molding process, will be described below.

Once the molding fixture has been assembled, and the molded part has been formed (e.g., molded part 110 in FIG. 4), the molding fixture is operated to collapse the core device of the invention and eject the molded part. The separation/ejection process commences with the molding fixture substantially as shown in FIG. 4, wherein the core device of the invention is in its home position. In a first stage of the separation/ejection process, a mechanism for separating the molding fixture (not shown) is activated to execute the first stage of separation. The mechanism for causing the separation is not of importance to the invention, but the inventors herein have employed a set of latch locks. In this first stage of the ejection process, the molding fixture is separated at the interface between plates 100 and 102. The result of this first stage of separation (as compared to FIG. 4) is shown in FIG. 20. As it relates to the mechanically-collapsible core device of the invention, as seen in FIG. 20, central pin 2 remains at a relatively constant position from its home position shown in FIG. 4. The remainder of the core device of the invention, however, translates in the direction of arrow C due to the first stage of separation. Thus, in relation to central pin 2, first collapsible core members 3 translate linearly along the axis of central pin 2, and this translation, due to the tapered grooves in the pin and the engaging members of the first collapsible core members, causes the first collapsible core members to collapse inward (see, FIG. 17). Thus, the first stage of collapse of the core device of the invention is accomplished. It should be noted that, as seen in FIG. 20, plates 104a and 104b, to which pins 55 are attached, translate together with the upper portion of the molding fixture. In practicing the invention, the inventors herein have employed a three inch movement in the first stage of separation. Thus, the distance between the adjoining surfaces of plates 102 and 100 as seen in FIG. 20 corresponds to the three inch movement.

In a second stage of the separation/ejection process, the mold members are separated from the molded part 110. In FIG. 20, the members of the molding fixture that are enclosed by dashed line 115 are separated to allow slide elements 112a and 112b and mold elements 111a and 111b to be moved back in the direction of arrows A and B, thereby allowing the molded part to be ejected. This second stage of the separation process is not necessarily important to the operation of the core device of the invention, but rather, is merely illustrative of the process for ejecting a molded part in a molding fixture that employs the core device of the invention.

The third stage of the separation/ejection process is controlled by externally mounted hydraulic cylinders (not shown). The hydraulic cylinders employed by the inventors have a total of eight inches of movement. The first three inches of the hydraulic cylinder movement controls movement of the second collapsible core members 4 so as to translate those members linearly three inches along the axis of the base member 8 away from shoulder 48 of the base member. This movement results in the collapse of the second collapsible core members as seen in FIG. 18. The cylinders also control the movement of plates 101 and 105. These two plates are preferably held together with a set of friction pullers through the first three inches of hydraulic cylinder movement. As the three-inch movement is made, simultaneously, the ejector system travels its last three inches of movement. After this last three inches of movement, the ejector system stops and the pressure from the cylinders overcomes the friction pullers, thereby allowing the system to move the final five inches of the cylinder movement to eject the molded part from the core device.

While the invention has been described with particular embodiments, it can readily be understood that various modifications could be implemented to achieve substantially the same result as the embodiments described herein. For example, while the engaging members of the pin and base member have been described as constituting grooves, and the engaging members of the first and second collapsible core members and the base member have been described as constituting a rail that slidably fits into the grooves of the base member, any other type of mechanism that provides the various members to function in the manner described herein could be utilized instead. Thus, it is to be understood that the invention is not limited to the above-described embodiments and that various changes and modifications may be made by those of ordinary skill in the art without departing from the spirit and scope of the invention.

What is claimed is:

1. A mechanically-collapsible core device, comprising:
a central pin having a plurality of engaging members;
a plurality of first collapsible core members each having an engaging member that engages with a respective engaging member of the central pin, wherein when the pin is translated in a first direction along a central axis of the pin while the first collapsible core members remain stationary relative to the translation of the pin, each engaging member of the pin and the respective engaging member of the first collapsible core member cooperate to cause each of the first collapsible core members to translate toward the central axis of the pin;
a base member having a plurality of engaging members; and
a plurality of second collapsible core members each having an engaging member that engages with a respective engaging member of the base member, wherein when the base member is translated in a first direction along a central axis of the base member while the first collapsible core members remain stationary relative to the translation of the base member, each engaging member of the base member and the respective engaging member of the second collapsible core member cooperate to cause each of the second collapsible core members to translate toward the central axis of the base member.

2. The mechanically-collapsible core device according to claim 1, wherein the engaging members of the pin are grooves that extend lengthwise along the pin from at least a middle portion of the pin to a first end of the pin.

3. The mechanically-collapsible core device according to claim 2, wherein the engaging members of the first core members are rails fitted to engage in a respective groove of the pin.

4. The mechanically-collapsible core device according to claim 3, wherein the pin is cylindrical and has a tapered diameter that tapers from a larger diameter at a middle portion of the pin along a length of the pin to a smaller diameter at a first end of the pin, and each groove in the pin has a tapered depth that is larger at the first end of the pin than at the middle portion of the pin.

5. The mechanically-collapsible core device according to claim 1, wherein the device comprises four first collapsible core members and four second collapsible core members.

6. The mechanically-collapsible core device according to claim 1, wherein the base member has a conical portion and the engaging members of the base member are grooves in a face of the conical portion extending lengthwise along the conical portion, and the base member further has a shoulder portion arranged at a base of the conical portion.

7. The mechanically-collapsible core device according to claim 6, wherein the engaging members of the second collapsible core members comprise rails that engage a respective groove in the conical portion of the base member.

8. The mechanically-collapsible core device according to claim 1, wherein the base member further has an orifice through the base member along the central axis of the base member that permits the central pin to be slidable engaged through the orifice.

9. The mechanically-collapsible core device according to claim 8, wherein the base member further has a plurality of first core member accommodating portions through the conical portion to the orifice, each first core member accommodating portion being arranged to slidable engage a respective first core member in a manner to permit the first core member to translate toward the central axis of the base member.

10. The mechanically-collapsible core device according to claim 9, wherein the first collapsible core members are connected with the base member in a manner to permit translation of each first core member toward the central axis of the base member through a respective accommodating portion, and to substantially retain a lengthwise position of each first core member in relation to the central axis of the base member.

11. The mechanically-collapsible core device according to claim 1, wherein:
i) the engaging members of the pin are grooves that extend lengthwise along the pin from at least a middle portion of the pin to a first end of the pin,
ii) the engaging members of the first core members are rails fitted to engage in a respective groove of the pin,
iii) the pin is cylindrical and has a tapered diameter that tapers from a larger diameter at a middle portion of the pin along a length of the pin to a smaller diameter at a first end of the pin, and each groove in the pin has a tapered depth that is larger at the first end of the pin than at the middle portion of the pin,
iv) the base member has a conical portion and the engaging members of the base member are grooves in a face of the conical portion extending lengthwise along the conical portion, and the base member further has a shoulder portion arranged at a base of the conical portion,
v) the engaging members of the second collapsible core members comprise rails that engage a respective groove in the conical portion of the base member,
vi) the base member further has an orifice through the base member along the central axis of the base member that permits the central pin to be slidable engaged through the orifice,
vii) the base member further has a plurality of first core member accommodating portions through the conical portion to the orifice, each first core member accommodating portion being arranged to slidable engage a respective first core member in a manner to permit the first core member to translate toward the central axis of the base member, and
viii) the first collapsible core members are connected with the base member in a manner to permit translation of each first core member toward the central axis of the base member through a respective accommodating portion, and to substantially retain a lengthwise position of each first core member in relation to the central axis of the base member.

12. The mechanically-collapsible core device according to claim 11, wherein, when the device is assembled at a home position, the central pin is slidably engaged into the orifice of the base member, the first collapsible core members are inserted into the accommodating portion of the base member with the rails of the first collapsible core members being engaged with the grooves of the central pin inserted through the orifice, and the rails of the second collapsible core members are engaged with the grooves in the conical portion of the base member with a first end of the second collapsible core members engaging the shoulder portion of the base member,
wherein the central pin is inserted through the orifice to a depth such that the first end of the pin, a first end of each first collapsible core member, a first end of the base member, and a first end of each second collapsible core member are substantially even, whereby a second end of each first collapsible core member is adjacent the shoulder portion of the base member, and a second end of each second collapsible core member is adjacent the shoulder portion of the base member.

13. The mechanically-collapsible core device according to claim 12, wherein the device is reconfigured from the home position to a first retracted position by retracting the central pin from the orifice of the base member a predetermined amount, the retraction of the pin resulting in each of the first collapsible core members engaged with the pin translating toward the central axis of the base member with the second end of each first collapsible core member remaining substantially adjacent the shoulder portion of the base member.

14. The mechanically-collapsible core device according to claim 13, wherein the device is reconfigured from the first retracted position to a second retracted position by retracting the base member a predetermined amount in a same direction as the retraction of the central pin, the retraction of the base member resulting in each of the second collapsible core members translating both toward the central axis of the base member and along central axis of the base member so that the second end of each second collapsible core member translates away from the shoulder portion of the base member.

15. The mechanically-collapsible core device according to claim 1, wherein the device for an injection molding process for forming a part.

16. The mechanically-collapsible core device according to claim 13, wherein, when assembled at the home position, at least a portion of an outer periphery surface of the device formed by the first collapsible core members, the second collapsible core members, the base member and the central pin conforms to a surface of a part to be molded.

17. The mechanically-collapsible core device according to claim 16, wherein at least a portion of the outer periphery surface conforming to the surface of the part to be molded forms a stepped-down diameter with a surface lip.

18. A method for ejecting a molded part from a mechanically-collapsible core device that is comprised of a central pin, a plurality of first collapsible core members engaged with the central pin by a first engagement mechanism, a base member, and a plurality of second collapsible core members engaged with the base member by a second engagement mechanism, the method comprising the steps of:
inducing a first stage of collapse of the core device by retaining the central pin in a relatively stationary position and translating the first collapsible core members, the base member and the second collapsible core members linearly along an axis of the central pin a predetermined distance, wherein the first engagement mechanism causes each of the first collapsible core members to translate inward toward the axis of the pin during the translation;
inducing a second stage of collapse of the core device by, commencing from a position resulting from the first stage of collapse, retaining the central pin and the base member in a relatively stationary position and translating each of the second collapsible core members linearly along an axis of the central pin a predetermined distance, wherein the second engagement mechanism causes each of the second collapsible core members to translate inward toward the axis of the pin during the translation; and
ejecting the molded part from the collapsed core device resulting from the second stage of collapse.
